(19) United States
(12) Patent Application Publication
(10) Pub. No.: US 2024/0078534 A1
(43) Pub. Date: Mar. 7, 2024

(54) VIRTUAL EXPERIENCE SUBSCRIPTIONS USING A VIRTUAL CURRENCY

(71) Applicant: Roblox Corporation, San Mateo, CA (US)

(72) Inventors: Enrico D'ANGELO, San Mateo, CA (US); Richard SIM, San Mateo, CA (US)

(73) Assignee: Roblox Corporation, San Mateo, CA (US)

(21) Appl. No.: 18/242,934

(22) Filed: Sep. 6, 2023

Related U.S. Application Data
(60) Provisional application No. 63/404,354, filed on Sep. 7, 2022.

(51) Int. Cl. G06Q 20/36

(52) U.S. Cl. CPC G06Q 20/367

(57) ABSTRACT

Some implementations relate to methods, systems, and computer-readable media for transferring subscriptions in virtual experiences. A user account is credited with virtual currency based on a periodic subscription to a digital distribution platform. The periodic subscription is examined and two or more time periods are calculated around the periodic subscription. As the user subscribes to subscription-based virtual experiences using the user account, virtual items, and services, the credited virtual currency is earmarked and reduced. At the end of each subscription period, virtual currency payments are made to respective developer accounts associated with the subscription-based virtual experiences using the earmarked virtual currency.

### CROSS-REFERENCE TO RELATED APPLICATIONS

This application claims the benefit of priority to U.S. Provisional Application Ser. No. 63/404,354, filed on Sep. 7, 2022, entitled “VIRTUAL EXPERIENCE SUBSCRIPTIONS USING A VIRTUAL CURRENCY,” the entire contents of which are hereby incorporated by reference herein.

### TECHNICAL FIELD

Embodiments relate generally to online virtual experience platforms, and more particularly, to methods, systems, and computer readable media for automatically transferring electronic subscription allotments across virtual experiences.

### BACKGROUND

Some interactive media systems, such as online virtual experience platforms, provide an opportunity for users to purchase items within an online virtual experience or to purchase a subscription to one more virtual experiences within a virtual experience platform. The virtual experience platform may provide user accounts to users to interact with virtual experiences and to play online games. The virtual experience platform may also provide user accounts to developers to provide virtual experiences on the virtual experience platform. Example embodiments are presented herein that relate to these and other concepts.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of this disclosure are directed to methods, systems, and computer readable media to transfer subscriptions across virtual experiences.

According to one aspect, a computer-implemented method is disclosed, comprising: receiving, at a virtual experience platform, a subscription approval signal from a digital distribution platform that is in operative communication with the virtual experience platform, wherein the subscription approval signal is associated with a user account of the virtual experience platform and comprises at least a monetary value to be transferred from the digital distribution platform to the virtual experience platform on a periodic basis; determining an amount of virtual currency associated with the monetary value; assigning a virtual credit of the amount of virtual currency to the user account; receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes an amount of virtual credit for each of the one or more virtual experiences during a first time period; determining that the user account is granted access to the one or more virtual experiences during the first time period; calculating, for the one or more virtual experiences, a respective developer payout in the virtual currency for the first time period based at least in part on the user account being granted access; determining that a second time period has ended, wherein the second time period is greater than or equal to the first time period; and after determining that the second time period has ended, transmitting an electronic payment in the virtual currency to a developer account of the respective developer at the virtual experience platform for each of the one or more virtual experiences, wherein the electronic payment is based on the respective developer payout for the first time period.

In some implementations, the first time period is one month, and wherein the second time period is greater than or equal to one month.

In some implementations, the determining that the user account is granted access is in response to the subscription request being determined as valid based on a subscription amount being less than or equal an available amount of virtual currency in the user account.

In some implementations, the determining that the user account is granted access includes accessing a log for a user session of the user account that is a subscriber account in the virtual experience platform.

In some implementations, the determining that the second time period has ended comprises determining that a fixed date at the end of the first time period has passed.

In some implementations, the fixed date occurs at or after one month from the receipt of the subscription approval signal.

In some implementations, the virtual experience subscription request is received at a first date, and wherein the fixed date occurs at or after one month from the first date.

In some implementations, the transmitting the electronic payment includes sending a virtual currency payment to the developer account.

In some implementations, the virtual experience subscription request is a first virtual experience subscription request, the computer-implemented method further comprising: receiving a second virtual experience subscription request associated with the user account, the second virtual experience subscription request being of a second amount less than or equal to the virtual credit reduced by the subscription amount, wherein the second virtual experience subscription request is associated with a second virtual experience associated with a respective developer; and adjusting the developer payout for the first time period based at least in part on the user account being granted access to the other virtual experience during the first time period, wherein the electronic payment is based on the adjusted developer payout.

In some implementations, the computer-implemented method further comprising: receiving a cancellation request associated with the user account, the cancellation request being for cancellation to at least one virtual experiences of the one or more virtual experiences during the first time period; and in response to receiving the cancellation request, adjusting the developer payout for the first time period, wherein the electronic payment is based on the adjusted payout.

In some implementations, the adjusted payout includes only non-cancelled virtual experience payouts.

According to another aspect, a non-transitory computer-readable medium is disclosed with instructions stored thereon that, responsive to execution by a processing device, causes the processing device to perform operations comprising: receiving a subscription approval signal from a digital distribution platform that is in operative communication with a virtual experience platform, wherein the subscription approval signal is associated with a user account and comprises at least a monetary value to be transferred from the digital distribution platform to the virtual experience platform on a monthly basis; determining an amount of virtual currency associated with the monetary value; assigning a virtual credit of the amount of virtual currency to the user account; receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes a proportion of virtual credit for each of the one or more virtual experiences during a first time period; determining that the user account is granted access to the one or more virtual experiences during the first time period; calculating, for the one or more virtual experiences, a respective developer payout in the virtual currency for the first time period based at least in part on the user account being granted access; determining that a second time period has ended, wherein the second time period is greater than or equal to the first time period; and after the determining that the second time period has ended, transmitting an electronic payment in the virtual currency to a developer account of the respective developer at the virtual experience platform for each of the one or more virtual experiences, wherein the electronic payment is based on the respective developer payout for the first time period.

In some implementations, the first time period is one month, and wherein the second time period is greater than or equal to one month.

In some implementations, the determining that the user account is granted access includes accessing a log for a user session of the user account that is a subscriber account in the virtual experience platform.

In some implementations, the determining that the second time period has ended comprises determining that a fixed date at the end of the first time period has passed.

In some implementations, the fixed date occurs at or after one month from the receipt of the subscription approval signal.

In some implementations, the virtual experience subscription request is received at a first date, and wherein the fixed date is greater than or equal to one month from the first date.

In some implementations, the transmitting the electronic payment includes sending a virtual currency payment to the developer account.

In some implementations, the virtual experience subscription request is a first virtual experience subscription request, the operations further comprising: receiving a second virtual experience subscription request associated with the user account, the second virtual experience subscription request being of a second amount less than or equal to the virtual credit reduced by the subscription amount, wherein the second virtual experience subscription request is associated with a second virtual experience associated with a respective developer; and adjusting the developer payout for the first time period based at least in part on the user account being granted access to the other virtual experience during the first time period, wherein the electronic payment is based on the adjusted developer payout.

In some implementations, the operations further comprise: receiving a cancellation request associated with the user account, the cancellation request being for cancellation to at least one virtual experiences of the one or more virtual experiences during the first time period; and in response to receiving the cancellation request, adjusting the developer payout for the first time period, wherein the electronic payment is based on the adjusted payout.

According to another aspect, a system is disclosed, comprising: a memory with instructions stored thereon; and a processing device, coupled to the memory and operable to access the memory, wherein the instructions when executed by the processing device, cause the processing device to perform operations including: receiving a subscription approval signal from a digital distribution platform that is in operative communication with a virtual experience platform, wherein the subscription approval signal is associated with a user account and comprises at least a monetary value to be transferred from the digital distribution platform to the virtual experience platform on a monthly basis; determining an amount of virtual currency associated with the monetary value; assigning a virtual credit of the amount of virtual currency to the user account; receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes a proportion of virtual credit for each of the one or more virtual experiences during a first time period; determining that the user account is granted access to the one or more virtual experiences during the first time period; calculating, for the one or more virtual experiences, a respective developer payout in the virtual currency for the first time period based at least in part on the user account being granted access; determining that a second time period has ended, wherein the second time period is greater than or equal to the first time period; and after the determining that the second time period has ended, transmitting an electronic payment in the virtual currency to a developer account of the respective developer at the virtual experience platform for each of the one or more virtual experiences, wherein the electronic payment is based on the respective developer payout for the first time period.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram of an example system architecture to implement transfer of subscriptions across virtual experiences, in accordance with some implementations.

FIG. 3 is a schematic of a user interface for selecting subscriptions, in accordance with some implementations.

FIG. 4 is a Gantt-style chart of time periods for subscription access and payouts across virtual experiences, in accordance with some implementations.

FIG. 5 is a flowchart of an example method of transferring subscriptions across virtual experiences, in accordance with some implementations.

FIG. 6 is a block diagram illustrating an example computing device, in accordance with some implementations.

### DETAILED DESCRIPTION

In the following detailed description, reference is made to the accompanying drawings, which form a part hereof In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

In some aspects, systems and methods are provided for transferring subscriptions across virtual experiences. Online platforms, such as online virtual experience platforms, generally provide an ability to create, store, advertise, and present for purchase virtual items, virtual experiences, as well as subscriptions, associated with virtual experiences.

Virtual experience platforms may include user-generated content or developer-generated content (each referred to as “UGC” herein). The UGC may be stored and implemented through the virtual experience platform, for example, by allowing users to search and interact with various virtual experiences and/or virtual items. Virtual items and virtual experiences may be presented in a search interface or inventory screen, whereby users may peruse and/or purchase virtual items and/or virtual experiences. However, if the user is accessing the virtual experience platform on a device that uses a digital distribution platform, such as an “App Store,” purchases may be controlled through the digital distribution platform.

For example, the digital distribution platform may allow only some purchases, may restrict some purchases, may only allow a particular number of purchases per month or time period, and/or may have other restrictions in place. These restrictions may make it difficult for users to request and purchase one or more subscriptions that may require periodic transactions or payments.

Example embodiments may effectuate subscription purchases by allowing transfer of virtual currency based on a platform subscription, associated with a virtual experience of a virtual experience platform. The platform subscription may be a first purchase through the digital distribution platform for a fixed amount of virtual currency. The platform subscription may refresh based on a time period dictated by the digital distribution platform (e.g., monthly, bi-monthly, semi-monthly, etc.). The virtual experience platform may track and credit the virtual currency to a user identifier (ID) based user account. The virtual experience platform may also calculate one or more time periods for granting access to content subscriptions for the user ID, without requiring multiple transactions through the digital distribution platform. In this manner, the virtual experience platform may transfer portions of the platform subscription on the digital distribution platform to establish content subscriptions for the user ID on the virtual experience platform, without causing superfluous transaction activity at the digital distribution platform.

The user ID may be granted access to several content subscriptions at any time within a defined subscription time period, and the user associated with the user ID may utilize the subscription to access virtual items, private servers, high Quality-of-Service (QOS) packages, private chat functionality, and/or other services provided by the virtual experience platform on a subscription-basis. In some implementations, the defined subscription time period may include a sliding window of a free trial period whereby the user can also utilize the subscription on a trial-basis. The sliding window of the free trial period may be based on the subscription refresh rate of virtual currency provided through the digital distribution platform, and on a point in time at which a subscription request is made, thereby ensuring that the user is granted subscription-level access for at least a time period that is greater than or equal to the platform subscription period.

According to implementations and embodiments described herein in detail, an online virtual experience platform may deploy a subscription component at a server. The subscription component may provide transfer of portions of a platform subscription from the digital distribution platform to individual virtual experiences and other virtual items and services available on the virtual experience platform on a subscription basis. Such transfer may be based on subscription data and user data received from the digital distribution platform, These and other suitable example embodiments will become apparent in this disclosure.

It is noted that any use of user and/or developer data for any purpose is specifically with permission from the user, in accordance with applicable regulations, and can be turned off by the user. Users can also choose what data to permit for such use. User data is stored securely and in compliance with applicable rules and laws. Furthermore, data collection is not performed in certain geo locales, for certain user categories (e.g., based on age or other demographic), is temporary (data are discarded after a period of time), and is stored securely even when only used temporarily. Moreover, user data are not shared with third-parties unless specific consent is provided by the user for such sharing. Even further, some data may be modified to remove personally identifiable information (PII), aggregated across users, or otherwise modified so that a specific user identity cannot be determined.

Hereinafter, further details surrounding example embodiments and various aspects of this disclosure are described with reference the many figures.

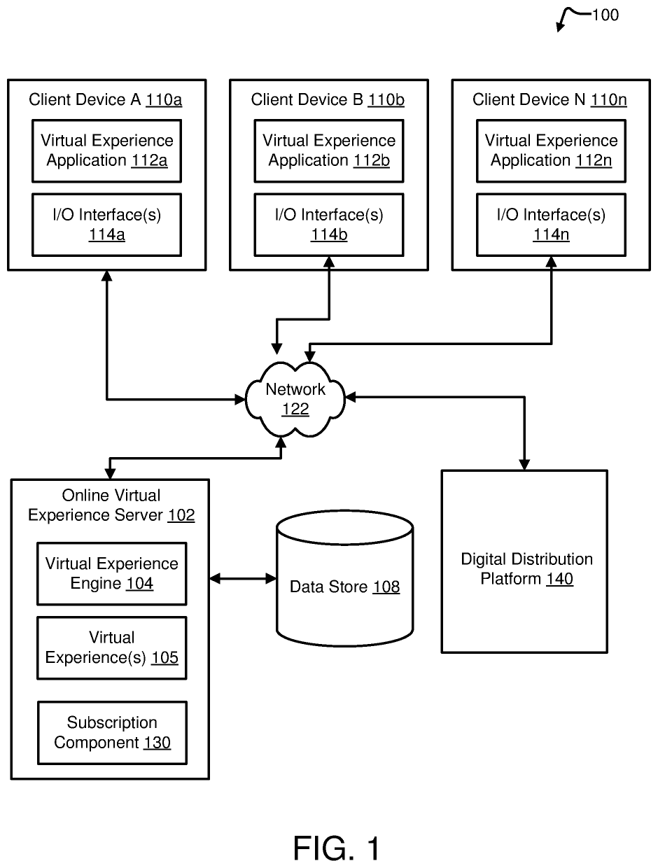

### FIG. 1: System Architecture

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, one or more client devices, and a digital distribution platform 140, all coupled via a network 122.

The online virtual experience server 102 can include, among other things, a virtual experience engine 104, one or more virtual experiences 105, and a subscription component 130. The online virtual experience server 102 may be configured to provide virtual experiences 105 to one or more client devices 110, and to provide transfer of subscriptions via the subscription component 130, in some implementations. Furthermore, as will be described more fully below, the subscription component 130 may also direct payouts to developers that develop the virtual items or experiences that are subscribed to.

Data store 108 is shown coupled to online virtual experience server 102 but in some implementations, can also be provided as part of the online virtual experience server 102. The data store may, in some implementations, be configured to store subscription data, user data, and/or other data in association with the subscription component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include subscription-based items or services as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. The user may, utilizing an app store or other service provided by the digital distribution platform 140, approve a subscription for a fixed amount of virtual currency on a time-period subscription-basis. In some implementations, the digital distribution platform may be operated by a party that is different from a party that operates the virtual experience server 102. For example, digital distribution platform 140 may be operated by a device or operating system provider (e.g., Apple App Store, Google Play, Amazon Appstore, Windows Store, etc.), a gaming console maker (e.g., Microsoft Xbox, Sony Playstation, Nintendo, etc.), a streaming games provider, etc. The subscription data may be transmitted to the subscription component 130, where an amount of virtual currency and the time period of the subscription are associated with the user's user ID.

Thereafter, the user may select various subscriptions through the virtual experience application 112. The selected subscriptions may be granted based on the time of request as well as the amount of virtual currency allotted to the user ID. The user may edit the subscription, add new subscriptions, and otherwise interact as if purchasing subscriptions directly from the virtual experience application based on the credit of virtual currency. Technical effects and benefits of this approach include improved user engagement, reduced transactions through the digital distribution platform, improved revenue for developers of UGC, as well as improved safety in transactions in the virtual metaverse.

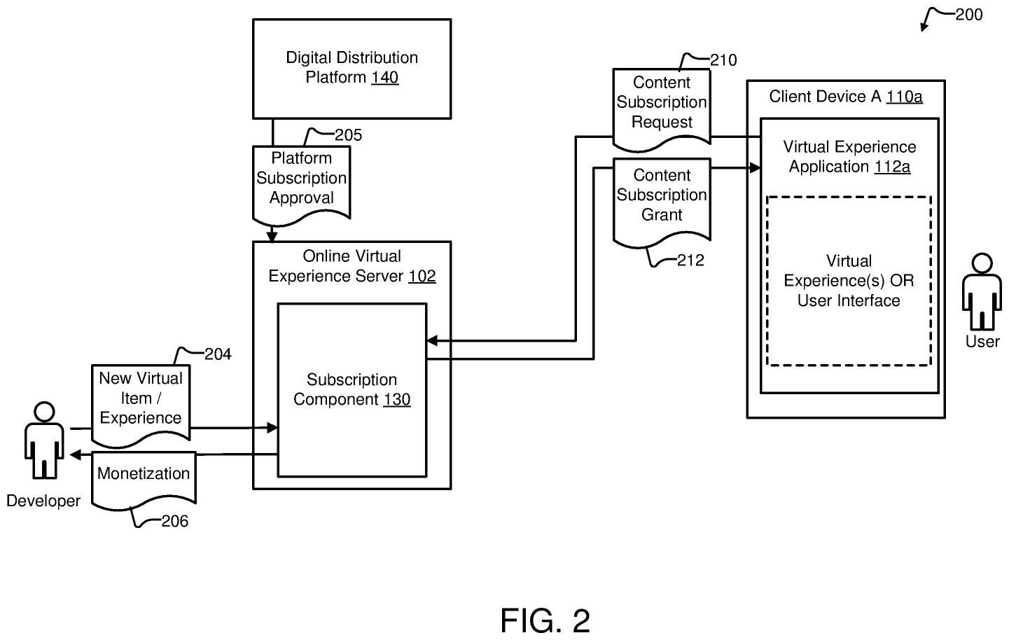

### FIG. 2: Flow Diagram of Transferring Subscriptions

FIG. 2 is a flow diagram of an example system architecture 200 to provide transfer of subscriptions across virtual experiences, in accordance with some implementations.

The system architecture 200 (also referred to as a “sub-system” herein) includes the online virtual experience server 102, subscription component 130, a client device 110a executing virtual experience 112, and the digital distribution platform 140. Online virtual experience server 102, client device 110, and digital distribution platform 140 may be arranged as described above with reference to FIG. 1, namely, in operative communication over network 122 (not illustrated here for clarity).

In one example, a developer may create a new virtual item or experience 204 for deployment and use through the virtual experience platform. The new virtual item or experience 204 may be made available via the subscription component 130 of the virtual experience server 102. A user may also establish a subscription to purchase virtual currency on a time-period subscription-basis from the digital distribution platform 140 associated with the client device 110. A subscription approval signal 205 may then be transmitted from the digital distribution platform 140 to the subscription component 130 or another component of the online virtual experience server 102 or the platform 100. In response to receipt of the subscription approval signal 205, virtual experience server 102 may associate a credit to a user account to a user associated with the signal 205, e.g., a user of client device 110a. The credit may be for an amount in virtual currency of the virtual experience server (platform) equivalent to a real currency amount indicated in the signal 205.

The new virtual item or experience 204 may be surfaced to the user through the virtual experience application 112, such as through a search interface, browser interface, or other user interface, and/or from within a virtual experience. The user viewing the new virtual item or experience 204 may select a subscription-based access plan for the item 204 through the virtual experience application 112. The selections may be transmitted from the virtual experience application 112 as a subscription request 210, to the subscription component 130. The subscription request may include a request to subscribed to one or more virtual experiences, virtual items, virtual services, or other subscription-based services made available by the virtual experience server 102 for subscription by the user.

The subscription component 130 may take as input the virtual item 204 and subscription approval signal 205, and create a subscription profile and/or user account with subscription access for the respective user. For example, the subscription component may determine an amount of virtual currency associated with the subscription approval signal 205, may assign a virtual credit of the amount of virtual currency to the user account, and may determine the time period of the platform subscription from the digital distribution platform 140.

Thereafter, the subscription component 130 may issue a subscription grant 212 to the client device 110. For example, if the subscription request has a total virtual currency value of less than or equal to the amount in the user account, the subscription component 130 may automatically grant the subscription(s) from the subscription request 210 for the determined time period. The user may then access the subscription-based virtual experiences, virtual items, and other services as if a purchase of a content subscription was made.

In some implementations, a user may periodically (at any time) edit subscriptions on the online virtual experience platform. In these instances, the subscription component 130 may re-allocate virtual currency in the user account based on the edited subscriptions.

In some implementations, a user may freely use a subscription-based virtual experience, virtual item, and other services for a free-trial period that may overlap the platform subscription to the digital distribution platform. In these instances, the user is granted access for a minimum of the platform subscription time period in addition to the free trial period. In this manner, a user may always be ensured access for at least the subscription time period.

In some implementations, the subscription component 130 is further configured to dynamically change content subscriptions one or more times during a free trial period, if the user requests content subscription changes during the free trial period.

In some implementations, if the user has been granted access for the entirety of a first time period greater than or equal to the platform subscription time period, the subscription component may calculate, for each content subscription, a respective developer payout in the virtual currency based at least in part on the user account being granted access. After a second time period has ended which is longer than the first time period, the subscription component 130 may transmit an electronic payment in the virtual currency to a developer account of the respective developer at the virtual experience platform for each of the one or more content subscriptions. The electronic payment is based on the respective developer payout for the platform subscription time period or the first time period—e.g., the electronic payment for a first developer having a first content subscription of X virtual currency for one month, equals X virtual currency for every full month per user that has been granted access to the first content; the electronic payment for a second developer having a second content subscription of Y virtual currency for one month and a third content subscription of Z virtual currency for one month, equals Y virtual currency for every full month per user that has been granted access to the second content, and Z virtual currency for every full month per user that has been granted access to the third content; and so on.

In some implementations, the second time period begins at a fixed date on a monthly basis. The fixed date may be any date within a particular month.

In some implementations, the second time period begins at a variable date based on the first subscription request a user issues. In these instances, the variable date becomes a fixed date upon establishment. Therefore, while the date may differ among different users, it will remain fixed for each particular user.

In some implementations, the second time period is equal to the sum of the first time period and the free trial period. Accordingly, the free trial period denotes a delay between the commencement of the first time period from the commencement of the second time period. However, it is noted that the length of the first time period may also be fixed to be the same length as the platform subscription time period. In this manner, the first time period represents a delayed window for virtual currency payouts to be calculated. However, this delayed window may enable improved coordination of subscription payouts, improved user engagement through use of the free trial period, as well as improved safety in virtual transactions by allowing subscriptions to be made in virtual currency rather than through multiple financial transactions.

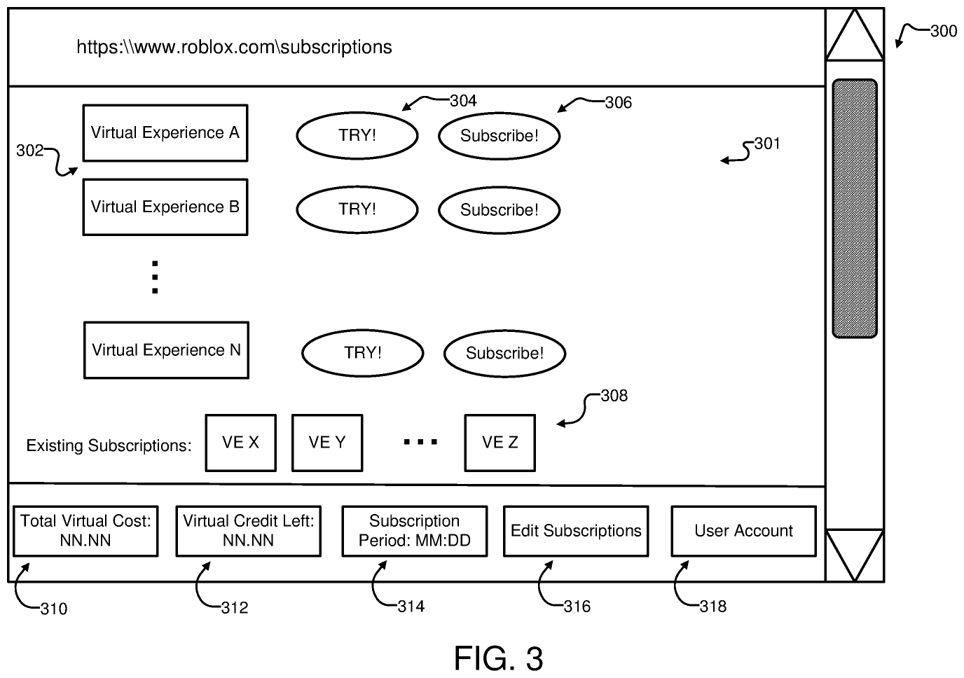

Hereinafter, example user interfaces for requesting subscriptions are described in detail below with reference to FIG. 3.

### FIG. 3: Subscription Requests

FIG. 3 is a schematic of a user interface for selecting subscriptions, in accordance with some implementations. It is noted that the description provided in reference to FIG. 3 is illustrative only, and not limiting. For example, actual appearance of a subscription-based items or services may be varied in many ways. Furthermore, the number, types, and displayed user interface elements may be altered in many ways. Moreover, the simplified schematic shown is for illustrative purposes only, and does not encompass all variations which may be applicable to example embodiments.

As shown, user interface 300 may include a main display portion 301 that includes a plurality of surfaced virtual experiences 302 for selection by a user. It is noted that while illustrated as virtual experiences 302, the user interface may be varied to include virtual items, virtual services, and/or any other subscription-based item or service accessible through the online virtual experience platform 100.

The user interface 300 may also include a plurality of control elements 304 and 306, each associated with a particular subscription-based item. For example, selection of control element 304 may allow a user to try a virtual experience, to try on a virtual item or accessory, to run a trial of a subscription service, or otherwise temporarily experience a subscription-based item. For example, selection of control element 306 may indicate that the user wishes to subscribe to the selected subscription-based item.

The user interface 300 may also include a display of existing subscriptions 308. In this manner, the user interface 300 may inform the user of newly surfaced subscription-based items 302, as well as existing subscriptions associated with the user's account.

The user interface 300 may also include a display 310 of a total virtual currency cost associated with selected subscriptions and existing subscriptions. For example, the subscription component 130 may populate display 310 based on a calculation of costs associated with the selected subscription-based items and existing subscriptions. The display 310 may be altered to display either total costs of only newly selected subscriptions or only existing subscriptions, in some implementations.

The user interface 300 may also include a display 312 of available virtual credit for subscriptions in the user's account. For example, the subscription component 130 may populate display 312 based on available virtual currency associated with subscriptions. It is noted that this display 312 does not indicate all virtual currency available, but only virtual currency available through the periodic subscription from the digital distribution platform.

The user interface 300 may also include a display 314 of the platform subscription period, other subscription periods, and/or a free trial period. For example, the subscription component 130 may populate the display 314 based on a current date and the platform subscription time period from the digital distribution platform.

The user interface 300 may also include a control element 316 to allow the user to edit existing subscriptions on the virtual experience platform 100. It is noted that control element 316 does not directly access the digital distribution platform or allow editing of the platform subscription. Selection of the control element 316 may render a new user interface allowing the user to edit content subscriptions on the virtual experience platform 100.

The user interface 300 may also include control element 318 to allow the user to access the user's account. Selection of the control element 318 may render a new user interface allowing access to the user's account page.

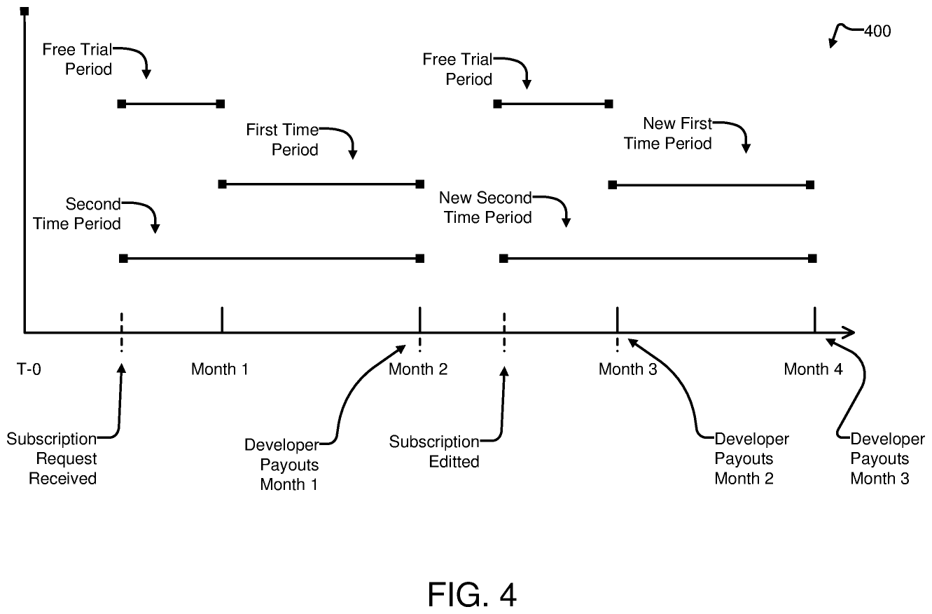

As described briefly above, upon transmittal of a subscription request by a user, for example using the user interface 300, the subscription component 130 may calculate two or more time periods for the user account in which subscriptions and subscription-based payouts to developers are calculated. Hereinafter, time periods associated with subscriptions are described in detail with reference to FIG. 4.

### FIG. 4: Time Periods

FIG. 4 is a Gantt-style chart of time periods for subscription access and payouts across virtual experiences, in accordance with some implementations. It is noted that the description provided in reference to FIG. 4 is illustrative only, and not limiting. For example, actual time periods of a subscription-based items or services may be varied in many ways. Furthermore, the number, types, and dates of the time periods may be varied. Moreover, the simplified schematic shown is for illustrative purposes only, and does not encompass all variations which may be applicable to example embodiments.

As shown, a time scale based on a platform subscription time period of one month is illustrated. However, any suitable time period for subscriptions may also be applicable. Accordingly, while the below description is provided with reference to monthly subscriptions, any other subscription period may also be applicable.

The time scale is divided into four months for simplicity of description. However, it should be readily understood that the time scale may extend into the future for any perceivable amount of time.

Time T-0 on the time scale denotes the beginning of this example description. In this example, time T-0 is the establishment of a user account on the virtual experience platform. The user account may also be associated with a user account on the digital distribution platform 140. The user account of the digital distribution platform 140 may include a user ID and/or device ID that may be used to link the user account on the virtual experience platform with the user account on the digital distribution platform 140.

Upon selecting one or more subscription-based items (e.g., virtual experiences, virtual items, virtual services, etc.), both a free trial period and a second time period are established by the subscription component 130. During the free trial period, the user may freely use any selected subscription prior to calculation of payouts to developers. The free trial period is a sliding window that begins upon receipt of the subscription request and ends on the beginning of the subsequent month of the platform subscription period.

Upon granting access to the selected subscription-based items, and upon the beginning of the next period in the platform subscription period (e.g., beginning of Month 1), the first time period begins. During the first time period, the user has full access to the selected subscription-based items for use during the entire first time period. The second time period and the first time period end at the end of that month, or the beginning of the subsequent month (e.g., Month 2). At the end of the second time period and the first time period, developer payouts are calculated and transmitted based on the user having access to the subscription-based items during the first time period.

In this example, all subscriptions are edited in the second month, and a new free trial period and second time period are calculated by the subscription component 130. However, if the subscriptions were not edited, a new first time period would begin at the end of the first month and extend through the entirety of the second month.

Continuing in the example of the edited subscriptions, at the beginning of Month 3, the user's new first time period begins where payouts are determined for each respective developer for payout at the end of Month 3. However, if the subscriptions were not edited, payouts for Month 2 would be made at the beginning of Month 3.

The calculations of new time periods may continue dependent upon how and when a user edits subscriptions. Payouts to respective developers continue on the monthly basis for every month a user has full access to a subscription-based item for the entirety of a first time period.

As described above, a user may select new subscriptions, edit existing subscriptions, and free trial some subscriptions, while the subscription component 130 continues to calculate time periods for full access and trial access, as well as developer payouts. The user does not need to continually engage with the digital distribution platform to establish and transfer portions of the platform subscription. Instead, the online virtual experience platform 100 performs all content subscription calculations for the user thereby allowing the benefit of improved user engagement as well as simplified processing of transactions for the digital distribution platform.

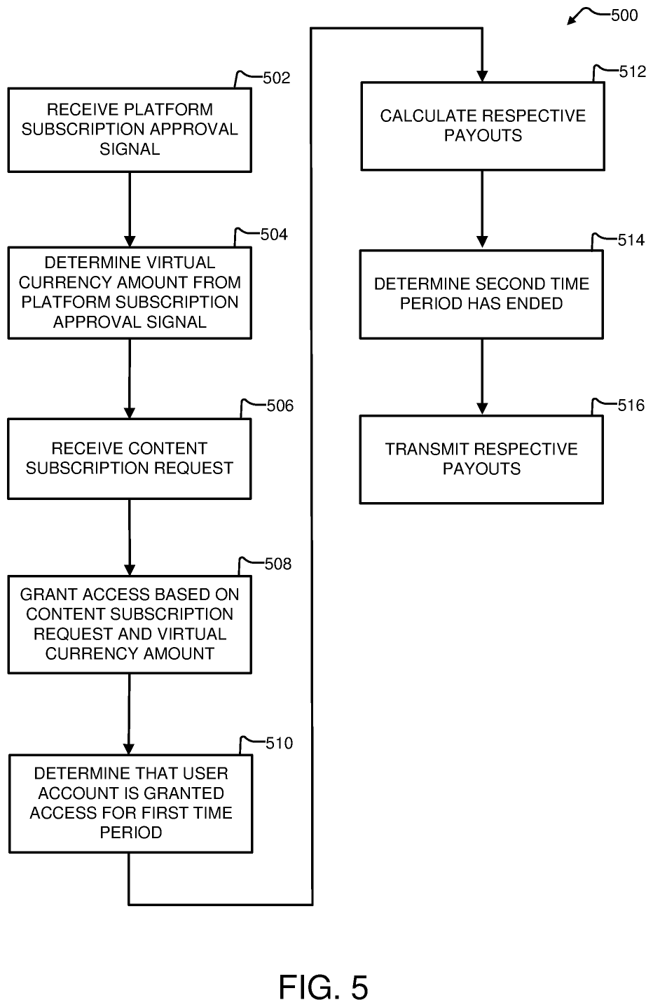

Hereinafter, methods of transferring subscriptions across virtual experiences are described in detail with reference to FIG. 5.

### FIG. 5: Method of Transferring Subscriptions

FIG. 5 is a flowchart of an example method of transferring subscriptions across virtual experiences, in accordance with some implementations.

In some implementations, method 500 can be implemented, for example, on a server 102 described with reference to FIG. 1 and FIG. 2. In some implementations, some or all of the method 500 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can send results or data to the first device.

In some implementations, the method 500, or portions of the method, can be initiated automatically by a system. In some implementations, the implementing system is a first device. For example, the method (or portions thereof) can be periodically performed, or performed based on one or more particular events or conditions, e.g., a time since last subscription request, a predetermined time period having expired since the last performance of method 500 for a particular subscription-based item or user, and/or one or more other conditions occurring which can be specified in settings read by the method.

Method 500 may begin at block 502. At block 502, a platform subscription approval signal is received from a digital distribution platform that is in operative communication with a virtual experience platform. The platform subscription approval signal is associated with a user account and comprises at least a monetary value to be transferred from the digital distribution platform to the virtual experience platform on a periodic basis, e.g., monthly or at other periodicity. Block 502 is followed by block 504.

At block 504, an amount of virtual currency associated with the monetary value is determined, and a virtual credit of the amount of virtual currency is assigned to the user account. In some implementations, the monetary value fluctuates. In some implementations, monetary value fluctuations are handled by calculating monetary amounts based on a fixed period of time. In some implementations, monetary value fluctuations are handled by determining the monetary amount at a particular point in time. In some implementations, monetary value fluctuations are handled with hysteresis based upon, for example, a calculated exchange rate that can change if a threshold amount of change to an actual exchange rate (e.g., 0.01%; 0.1%; 1.0%; or others) is applicable at a particular point in time. Block 504 is followed by block 506.

At block 506, a virtual experience content subscription request is received. The virtual experience content subscription request is associated with the user account. A content subscription amount from the content subscription request is less than or equal to the virtual credit. The virtual experience content subscription request is for one or more virtual experiences (or other virtual content) hosted on the virtual experience platform, with each virtual experience of the one or more virtual experiences associated with a respective developer. Additionally, the virtual experience content subscription request includes an amount of virtual credit for each of the one or more virtual experiences during a first time period. Block 506 is followed by block 508.

At block 508, the user account is granted access to the one or more virtual experiences in the content subscription request based on the content subscription request and the virtual currency amount. For example, a content subscription grant signal may be transmitted by the subscription component 130 to a user device and/or virtual experience application 112, granting access to the subscribed virtual experiences. Block 508 is followed by block 510.

At block 510, the user account is determined to have been granted access to the one or more virtual experiences during the first time period. Upon such grant, the user may access the virtual experience (e.g., that may be locked or restricted from use by non-subscribers), may obtain subscriber privileges to the virtual experience (e.g., access to restricted portions, access to subscriber-only items, ability to engage in chat or interaction with other subscribers, etc.). For example, this may include accessing a log for a user session of the user account that is a subscriber account in the virtual experience platform. The log may also be used to determine engagement metrics and other measurable values for how a user is interacting with a subscribed virtual experience. Block 510 is followed by block 512.

At block 512, a respective developer payout in the virtual currency for the first time period is calculated, for the one or more virtual experiences, based at least in part on the user account being granted access. For example, the log described with reference to block 510 may be accessed to ascertain that the user was granted access for the entirety of the first time period. Block 512 is followed by block 514.

At block 514, it is determined that a second time period has ended. The second time period is greater than or equal to the first time period. For example, the second time period may be a time period greater than or equal to the platform subscription period, as well. In this manner, the second time period encompasses both a sliding window free trial time period and the first time period. Block 514 is followed by block 516.

At block 516, an electronic payment in the virtual currency is transmitted to a developer account of the respective developer at the virtual experience platform for each of the one or more virtual experiences. The electronic payment is based on the respective developer payout for the first time period. In this manner, the electronic payment remitted to each developer reflects that a user had at least one full month of access to the subscription-based virtual experience. The developer may at any point redeem the virtual currency into a real currency (e.g., US dollar) via the virtual experience server 102.

It is noted that blocks 502-516 can be performed (or repeated) in a different order than described above and/or one or more blocks can be omitted. For example, blocks 502 and 506 may occur at the same or different times, and block 512 may be performed at any time during the second time period. Method 500 can be performed on a server (e.g., 102) and/or a client device (e.g., 110). Furthermore, portions of the method 500 may be combined and performed in sequence or in parallel, according to any desired implementation.

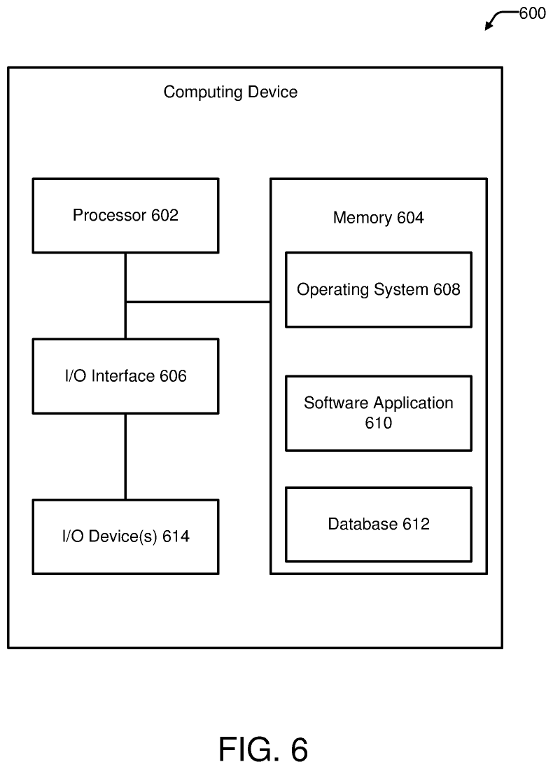

Hereinafter, a more detailed description of various computing devices that may be used to implement different devices and/or components illustrated in FIGS. 1-2 is provided with reference to FIG. 6.

FIG. 6 is a block diagram of an example computing device 600 which may be used to implement one or more features described herein, in accordance with some implementations. In one example, device 600 may be used to implement a computer device, (e.g., 102, 110 of FIG. 1 and FIG. 2), and perform appropriate operations as described herein. Computing device 600 can be any suitable computer system, server, or other electronic or hardware device. For example, the computing device 600 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614 (e.g., display screen, touchscreen, display goggles or glasses, audio speakers, headphones, microphone, etc.).

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 608, software application 610 and associated data 612. In some implementations, the applications 610 can include instructions that enable processor 602 to perform the functions described herein, e.g., some or all of the method of FIG. 5. Software application 610 may include some or all of the functionality required to process and transfer subscriptions, as described herein. In some implementations, one or more portions of software application 610 may be implemented in dedicated hardware such as an application-specific integrated circuit (ASIC), a programmable logic device (PLD), a field-programmable gate array (FPGA), a machine learning processor, etc. In some implementations, one or more portions of software application 610 may be implemented in general purpose processors, such as a central processing unit (CPU) or a graphics processing unit (GPU). In various implementations, suitable combinations of dedicated and/or general purpose processing hardware may be used to implement software application 610.

For example, software application 610 stored in memory 604 can include instructions for retrieving user data, for granting access to subscriptions, for calculating payouts to developers, and/or other functionality or software such as the subscription component 130, VE Engine 104, and/or VE Application 112. Any of software in memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. For example, network communication devices, storage devices (e.g., memory and/or data store 106), and input/output devices can communicate via interface 606. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 6 shows one block for each of processor 602, memory 604, I/O interface 606, software blocks 608 and 610, and database 612. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can also implement and/or be used with features described herein. Example user devices can be computer devices including some similar components as the device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 614, for example, can be connected to (or included in) the device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain implementations discussed herein may obtain or use user data (e.g., user demographics, user behavioral data, user contextual data, user settings for advertising, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method, comprising:
receiving, at a virtual experience platform, a subscription approval signal from a digital distribution platform that is in operative communication with the virtual experience platform, wherein the subscription approval signal is associated with a user account of the virtual experience platform and comprises at least a monetary value to be transferred from the digital distribution platform to the virtual experience platform on a periodic basis;
determining an amount of virtual currency associated with the monetary value;
assigning a virtual credit of the amount of virtual currency to the user account;
receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes an amount of virtual credit for each of the one or more virtual experiences during a first time period;
determining that the user account is granted access to the one or more virtual experiences during the first time period;
calculating, for the one or more virtual experiences, a respective developer payout in the virtual currency for the first time period based at least in part on the user account being granted access;
determining that a second time period has ended, wherein the second time period is greater than or equal to the first time period; and
after determining that the second time period has ended, transmitting an electronic payment in the virtual currency to a developer account of the respective developer at the virtual experience platform for each of the one or more virtual experiences, wherein the electronic payment is based on the respective developer payout for the first time period.

2. The computer-implemented method of claim 1, wherein the first time period is one month, and wherein the second time period is greater than or equal to one month.

3. The computer-implemented method of claim 1, wherein the determining that the user account is granted access is in response to the subscription request being determined as valid based on a subscription amount being less than or equal an available amount of virtual currency in the user account.

4. The computer-implemented method of claim 1, wherein the determining that the second time period has ended comprises determining that a fixed date at the end of the first time period has passed.

5. The computer-implemented method of claim 4, wherein the fixed date occurs at or after one month from the receipt of the subscription approval signal.

6. The computer-implemented method of claim 4, wherein the virtual experience subscription request is received at a first date, and wherein the fixed date occurs at or after one month from the first date.

7. The computer-implemented method of claim 1, wherein the transmitting the electronic payment includes sending a virtual currency payment to the developer account.

8. The computer-implemented method of claim 1, wherein the virtual experience subscription request is a first virtual experience subscription request, the method further comprising:
receiving a second virtual experience subscription request associated with the user account, the second virtual experience subscription request being of a second amount less than or equal to the virtual credit reduced by the subscription amount, wherein the second virtual experience subscription request is associated with a second virtual experience associated with a respective developer; and
adjusting the developer payout for the first time period based at least in part on the user account being granted access to the other virtual experience during the first time period, wherein the electronic payment is based on the adjusted developer payout.

9. The computer-implemented method of claim 1, further comprising:
receiving a cancellation request associated with the user account, the cancellation request being for cancellation to at least one virtual experiences of the one or more virtual experiences during the first time period; and
in response to receiving the cancellation request, adjusting the developer payout for the first time period, wherein the electronic payment is based on the adjusted payout.

10. The computer-implemented method of claim 9, wherein the adjusted payout includes only non-cancelled virtual experience payouts.

11. A non-transitory computer-readable medium with instructions stored thereon that, responsive to execution by a processing device, causes the processing device to perform operations comprising:
receiving a subscription approval signal from a digital distribution platform that is in operative communication with a virtual experience platform, wherein the subscription approval signal is associated with a user account and comprises at least a monetary value to be transferred from the digital distribution platform to the virtual experience platform on a monthly basis;
determining an amount of virtual currency associated with the monetary value;
assigning a virtual credit of the amount of virtual currency to the user account;
receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes a proportion of virtual credit for each of the one or more virtual experiences during a first time period;
determining that the user account is granted access to the one or more virtual experiences during the first time period;
calculating, for the one or more virtual experiences, a respective developer payout in the virtual currency for the first time period based at least in part on the user account being granted access;
determining that a second time period has ended, wherein the second time period is greater than or equal to the first time period; and
after determining that the second time period has ended, transmitting an electronic payment in the virtual currency to a developer account of the respective developer at the virtual experience platform for each of the one or more virtual experiences, wherein the electronic payment is based on the respective developer payout for the first time period.

12. The non-transitory computer-readable medium of claim 11, wherein the first time period is one month, and wherein the second time period is greater than or equal to one month.

13. The non-transitory computer-readable medium of claim 11, wherein the determining that the user account is granted access includes accessing a log for a user session of the user account that is a subscriber account in the virtual experience platform.

14. The non-transitory computer-readable medium of claim 11, wherein the determining that the second time period has ended comprises determining that a fixed date at the end of the first time period has passed.

15. The non-transitory computer-readable medium of claim 14, wherein the fixed date occurs at or after one month from the receipt of the subscription approval signal.

16. The non-transitory computer-readable medium of claim 14, wherein the virtual experience subscription request is received at a first date, and wherein the fixed date occurs at or after one month from the first date.

17. The non-transitory computer-readable medium of claim 11, wherein the transmitting the electronic payment includes sending a virtual currency payment to the developer account.

18. The non-transitory computer-readable medium of claim 11, wherein the virtual experience subscription request is a first virtual experience subscription request, the operations further comprising:
receiving a second virtual experience subscription request associated with the user account, the second virtual experience subscription request being of a second amount less than or equal to the virtual credit reduced by the subscription amount, wherein the second virtual experience subscription request is associated with a second virtual experience associated with a respective developer; and
adjusting the developer payout for the first time period based at least in part on the user account being granted access to the other virtual experience during the first time period, wherein the electronic payment is based on the adjusted developer payout.

19. The non-transitory computer-readable medium of claim 11, wherein the operations further comprise:
receiving a cancellation request associated with the user account, the cancellation request being for cancellation to at least one virtual experiences of the one or more virtual experiences during the first time period; and
in response to receiving the cancellation request, adjusting the developer payout for the first time period, wherein the electronic payment is based on the adjusted payout.

20. A system, comprising:
a memory with instructions stored thereon; and
a processing device, coupled to the memory and operable to access the memory, wherein the instructions when executed by the processing device, cause the processing device to perform operations including:
receiving a subscription approval signal from a digital distribution platform that is in operative communication with a virtual experience platform, wherein the subscription approval signal is associated with a user account and comprises at least a monetary value to be transferred from the digital distribution platform to the virtual experience platform on a monthly basis;
determining an amount of virtual currency associated with the monetary value;
assigning a virtual credit of the amount of virtual currency to the user account;
receiving a virtual experience subscription request associated with the user account and of a subscription amount less than or equal to the virtual credit, wherein the virtual experience subscription request is for one or more virtual experiences hosted on the virtual experience platform, each virtual experience of the one or more virtual experiences associated with a respective developer, and wherein the virtual experience subscription request includes a proportion of virtual credit for each of the one or more virtual experiences during a first time period;
determining that the user account is granted access to the one or more virtual experiences during the first time period;
calculating, for the one or more virtual experiences, a respective developer payout in the virtual currency for the first time period based at least in part on the user account being granted access;
determining that a second time period has ended, wherein the second time period is greater than or equal to the first time period; and
after determining that the second time period has ended, transmitting an electronic payment in the virtual currency to a developer account of the respective developer at the virtual experience platform for each of the one or more virtual experiences, wherein the electronic payment is based on the respective developer payout for the first time period.
